(19) United States
(12) Patent Application Publication
(10) Pub. No.: US 2002/0123452 A1
(43) Pub. Date: Sep. 5, 2002

(54) Zwitterionic gemini surfactants for use in carbon dioxide

(76) Inventors: Joseph M. DeSimone, Chapel Hill, NC (US); Jason S. Keiper, Hoffman Estates, IL (US); Fredric M. Menger, Decatur, GA (US); Andrey V. Peresypkin, Cranford, NJ (US); Caroline J. Clavel, Montpellier (FR)

Correspondence Address: MYERS BIGEL SIBLEY & SAJOVEC, PO BOX 37428, RALEIGH, NC, 27627, US

(21) Appl. No.: 10/056,354

(22) Filed: Jan. 24, 2002

Related U.S. Application Data
(60) Provisional application No. 60/264,163, filed on Jan. 25, 2001.

(51) Int. Cl. C07F 9/02; C11D 1/00

(52) U.S. Cl. 510/467; 568/8

(57) ABSTRACT

A surfactant comprises a first ionic group comprising at least one hydrocarbon-containing chain; a second ionic group comprising at least one hydrocarbon-containing chain, wherein the second ionic group has a charge opposite to the charge of the first ionic group; and a hydrocarbon spacer group covalently bonded to each of the first and second ionic groups. The surfactant is solubilized in carbon dioxide.

### CROSS-REFERENCE TO RELATED APPLICATIONS

The application claims priority to Provisional Application No. 60/264,163 filed Jan. 25, 2001, the disclosure of which is incorporated herein by reference in its entirety.

The present invention was made with Government support under Grant Number GM21457 from the National Institute of Health and Grant Number DAAG55-98-1-0167 from the Army Research Office. The Government has certain rights to this invention.

### BACKGROUND OF THE INVENTION

In the recent past, there has been a heightened interest in the solubilities and aggregation properties of small-molecule fluorosurfactants in liquid and supercritical carbon dioxide. See e.g., Kosani, et al. J. Supercritical Fluids 1990, 3, 51 and DeSimone et al., Curr. Opin. Solid State Materi. Sci., 2001, 5, 333. In particular,, such studies have largely focused on developing colloidal systems for various processes in carbon dioxide. Examples of various applications include reverse micelle formation, emulsions and microemulsions, enzyme-encapsulating water pools, metal chelation, small-scale synthesis in emulsions and microemulsions, and nanoparticle formation. See e.g., Fulton et al., Langmuir 1995, 11, 4241, Hoefling et al., Fluid Phase Equilibria 1993, 83, 203, and Jacobson et al. J. Org. Chem. 1999, 64, 1201. Systems that have arguably been most successful to date have primarily involved perfluoropolyether (PFPE) carboxylates, as well as sulfate and sulfonate fluorosurfactants. See e.g., Hoefling et al., Fluid Phase Equilibria 1993, 83, 203, Harrison et al., Langmuir 1994, 10, 3536, and Holmes et al., J. Phys. Chem. B, 1999, 103, 5703. The perceived paucity of amenable small-molecule surfactants serves to potentially restrict carbon dioxide's further exploitation as a environmentally advantageous solvent in a wide range of applications including, for example, cleaning processes, coatings, extractions, and polymerization processes.

There is a need in the art to provide surfactants and compositions containing such surfactants that address the above concerns.

### SUMMARY OF THE INVENTION

In one aspect, the invention provides a surfactant. The surfactant comprises a first ionic group comprising at least one hydrocarbon-containing chain, a second ionic group comprising at least one hydrocarbon-containing chain, wherein the second ionic group has a charge opposite to the charge of the first ionic group, and a hydrocarbon spacer group covalently bonded to each of the first and second ionic groups. The surfactant is soluble in carbon dioxide.

### BRIEF DESCRIPTION OF THE DRAWINGS

FIG. 1 illustrates various cloud point measurements for various surfactants encompassed by the invention.

FIG. 2 illustrates absorbance spectra for different water/surfactant ratios according to the present invention.

### DETAILED DESCRIPTION OF THE PREFERRED EMBODIMENTS

The invention will now be described with respect to the preferred embodiments set forth herein. It should be appreciated however that these embodiments are for illustrative purposes only, and do not limit the scope of the invention.

In one example, the invention provides a surfactant including a first ionic group, a second ionic group, and a hydrocarbon spacer group covalently bonded to each of the first and second ionic groups. The first ionic group and the second ionic group may be selected from various embodiments including, without limitation, those described herein.

The first ionic group may be present in various forms. As an example, the first ionic group may be a phosphorus-containing group. In one embodiment, for example, the first ionic group is of the formula:

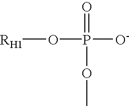

wherein R_{H1} is the hydrocarbon-containing chain. Numerous chains may be employed for R_{H1} including those which are linear and branched. For example, R_{H1} may be a partially fluorinated chain. In one embodiment, for example, R_{H1} is of the formula:

CₙF₂ₙ₊₁(CH₂)ₘ

wherein n ranges from 4 to 18 and m ranges from 0 to 12. In one preferred embodiment, n is 6 and m is 2. In another preferred embodiment, n is 8 and m is 2.

In another embodiment, R_{H1} is of the formula:

HF₂C(CF₂)ₙ(CH₂)ₘ

wherein n ranges from 3 to 18 and m ranges from 0 to 12.

The second ionic group encompasses a number of various groups. As an example, in one embodiment, the second ionic group may be a nitrogen-containing group. An example of a nitrogen-containing group is one of the formula:

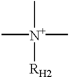

wherein R_{H2} is of the formula C_{q}H_{2q+1} wherein q ranges from 2 to 22 and is linear or branched or is an aromatic-containing group. One non-limiting example of an aromatic-containing group is:

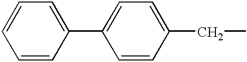

In one preferred embodiment, q is 8. In another preferred embodiment, q is 10. In another preferred embodiment, q is 12. Other values may be employed.

A number of spacer groups can be used in accordance with the invention. For example, the spacer group can be a hydrocarbon group that may be substituted, unsubstituted, branched, and/or unbranched. In one embodiment, the spacer group is of the formula:

(CH₂)ᵣ

wherein r ranges from 1 to 22. In one preferred embodiment, r is 2.

Substitutions in and/or pendant to the spacer “chain” can be made with any number of groups. In one embodiment, heteroatoms in the spacer “chain” may be present resulting, for example, in ether (C—O—C), thioether (C—S—C) groups, or amino (C—NR—C) linkages, although others can result. Heteroatoms on the spacer “chain” or pendant to the spacer “chain”, include, for example, halogens (e.g., F, Cl, Br), hydroxyls (e.g., OH) or polyethers (e.g., ethoxylates: (—CH₂CH₂O—)ₙH).

The spacer “chain” may contain unsaturation thereon by the inclusion of certain groups in or on the “chain”. Such groups include, for example, alkenyl and alkynyl groups. Spacer “chains” may also include therein a saturated cyclic group, with or without heteroatoms (such as, for example, cyclohexyl or morpholino). Aromatic groups, such as for instance xylyl (—C—Ph—C), may also be included in the spacer “chain”. Such aromatic groups may contain heteroatoms (for instance, as an example, pyridyl).

In another aspect, the invention comprises a composition of matter. The composition of matter comprises carbon dioxide; and a surfactant dissolved therein comprising a first ionic group comprising at least one hydrocarbon-containing chain; a second ionic group comprising at least one hydrocarbon-containing chain. The second ionic group has a charge opposite to the charge of the first ionic group. The surfactant also includes a hydrocarbon spacer group covalently bonded to each of the first and second ionic groups. Advantageously, the surfactant is solubilized in the carbon dioxide. Examples of such surfactants include those described herein.

The composition of matter may include various quantities of surfactant. For example, the composition of matter may include from about 0.5 weight percent of surfactant to about 2.5 weight percent of surfactant.

Although not intending to limit the invention, it is believed that there are numerous possible modes of self-assembly for the surfactant in the composition of matter. Such modes include, without limitation, micelles and reverse micelles. Additional modes of self-assembly could also include without limitation, micelles, reverse micelles, “wormlike micelles”, W/C and C/W microemulsions, W/C and CAN emulsions, lamellae, vesicles, monolayer films at bulk, CO₂-water interfaces, hexagonal phases, coacervates, and foams, as well as others.

For the purposes of the invention, carbon dioxide is employed in a liquid or supercritical phase in embodiments encompassing the composition of matter. A gaseous carbon dioxide phase can also be employed. The composition of matter (in the form of a solution) typically employs carbon dioxide as a continuous phase. Preferably, the composition of matter comprises from about 50, 60, or 75 to about 80, 90, or 99 percent by weight of carbon dioxide. If liquid CO₂ is used, the temperature employed during the process is preferably below 31° C. In one preferred embodiment, the CO₂ is utilized in a “supercritical” phase. As used herein, “supercritical” means that a fluid medium is at a temperature that is sufficiently high that it cannot be liquefied by pressure. The thermodynamic properties of CO₂ are reported in Hyatt, J. Org. Chem. 49: 5097-5101 (1984); therein, it is stated that the critical temperature of CO₂ is about 31° C. In particular, the compositions of matter of the present invention are preferably present at a temperature range from about 20° C. to about 60° C. The pressures employed preferably range from about 1000 psia (6.9 MPa) to about 5500 psia (37.9 MPa).

When applicable, the composition of matter may also comprise components in addition to those described above. Exemplary components include, but are not limited to, polymer modifier, water, rheology modifiers, plasticizing agents, antibacterial agents, flame retardants, and viscosity reduction modifiers.

Co-solvents and co-surfactants may also be optionally employed. For the purposes of the invention, the term “co-solvent” is to be broadly construed to denote solvents that may be used to solubilize or dissolve the surfactant in CO₂, or that may serve to homogenize the solutions. As an example, a monomer (e.g., methanol) can homogenize the solutions. Certain monomers can also serve to help dissolve or solubilize the surfactant. Additionally, a monomer can also dissolve in CO2 and associate minimally, if at all, with the surfactant.

Water may also be used in various capacities. As an example, water may be used as a co-solvent, as well as for other functions. In one embodiment involving water in the composition of matter, the water forms a microemulsion in the composition. For the purposes of the invention, the term “microemulsion” refers to the water being present in the form of nanometer-sized droplets, preferably ranging from about 5 nm to about 100 nm in diameter.

In embodiments in which the composition of matter includes water, the water and surfactant may be present in various amounts. For example, the composition of matter may comprise water-to-surfactant molar ratios ranging from about 1:1, 5:1, 25:1, or 75:1 at a lower end to about 125:1, 150: 200:1, 250:1, 500:1, 750:1, or 1000:1 at a higher end.

In another aspect, the invention encompasses a process which comprises utilizing the composition of matter as defined herein. Examples of such processes include, without limitation, cleaning processes, coating processes, polymerization processes, enzymatic reaction processes, extraction processes, and inorganic synthesis particle processes. The surfactants may also be used in conjunction with interfacial reaction media and serve in solvent pool formation for polymerization processes.

The following examples are intended to illustrate the invention, and are not intended to limit the scope of the invention.

### EXAMPLE 1

### Synthesis of Surfactant

A surfactant encompassed by the invention is synthesized according to the following route. The first step is carried out as follows:

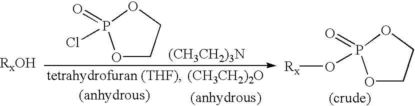

wherein Rₓ may be a hydrocarbon-chain or a partially fluorinated unit derived from commercially available alcohols. Examples of partially fluorinated units include CₙF₂ₙ₊₁(CH₂)ₘ wherein n ranges from 4to 18 and m ranges from 0 to 12 and HF₂C(CF₂)ₙ(CH₂)ₘ wherein n ranges from 4 to 18 and m ranges from 0 to 12.

The THF and (CH₃CH₂)₂O are initially present in a 1:1 volume ratio. This first step is carried out at 0° C. for 5 minutes, and subsequently at room temperature for 4 hours under an argon (Ar) atmosphere. The next synthesis step is thereafter carried out as follows:

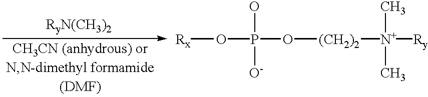

wherein R_{y} comprises a hydrocarbon unit derived from commercially-available or readily prepared N,N-dimethylalkylamines which can be varied in terms of length, degrees of unsaturation, or presence of ring structures as described in detail herein, or is an aromatic-containing unit including, but not? limited to, those set forth in the present application. Exemplary R_{y} substituents are of the formula C_{q}H_{2q+1} wherein q ranges from 2 to 22 or are aromatic-containing groups. The second step takes place at a temperature of from 65° C. to 70° C. for two days under an argon atmosphere.

Surfactant structure may be verified by ¹H, ¹³C, ¹⁹F and ³¹P NMR, as well as elemental analysis and mass spectroscopy.

### EXAMPLE 2

### Surfactant Solubility Studies

Solubility studies are carried out for a number of surfactants encompassed by the present invention, described in this example by formulas (I) through (IV). In particular, the surfactants are present in 1 weight percent solutions in supercritical carbon dioxide at temperatures ranging from 55° C. to 60° C. and pressures ranging from 5000 psi to 5500 psi add SI units.

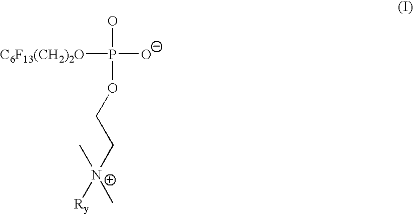

For formula (I) in this example, the surfactant is determined to be soluble in the CO₂ for the following R_{y} groups: C₈H₁₇, C₁₀H₂₁, C₁₂H₂₅, C₁₄H₂₉, C₁₆H₃₃, and C₁₈H₃₇. For formula (I), the surfactant is determined to be insoluble in CO₂ for the following R_{y} groups: C₂₀H₄₁, and

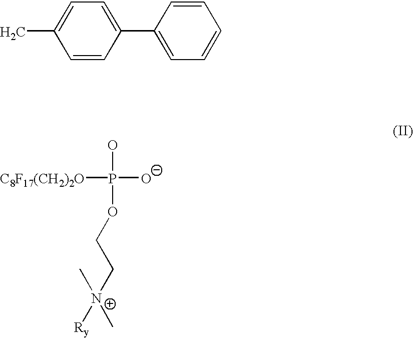

For formula (II) in this example, the surfactant is determined to be insoluble in the following R_{y} groups: C₁₄H₂₉ and C₂₂H₄₅.

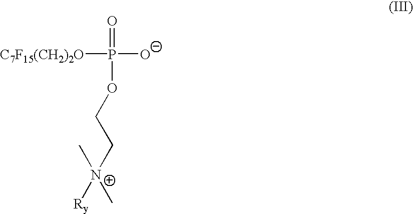

For formula (III) in this example, the surfactant is determined to be insoluble in the following R_{y} groups: C₈H₁₇, C₁₄H₂₉ and C₂₂H₄₅.

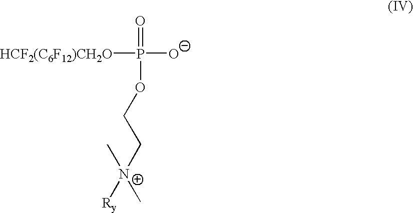

For formula (IV) in this example, the surfactant is determined to be insoluble in the following R_{y} groups: C₁₂H₂₅.

### EXAMPLE 3

### Cloud Point Measurements

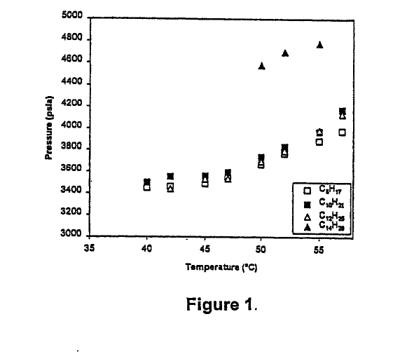

Cloud point measurements for various surfactants present at 1 weight percent in carbon dioxide are determined for various temperatures and pressures. The results are set forth in FIG. 1. The surfactant formula evaluated is:

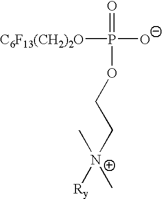

Different R_{y} substituents are listed in the insert in FIG. 1. Similar cloud point profiles are observed for Ry values of C₈H₁₇, C₁₂H₂₅ and C₁₂H₂₅ which precipitate at temperatures below 37°C.-40°C. at pressures up to 5500 psi add SI units. Additionally, the C₁₄H₂₉ analog possesses lower solubility relative to the other analogs and precipitates at temperatures below 47° C. at pressures up to 5500 psi add SI units.

### EXAMPLE 4

### Absorbance Study

UV-Vis spectra for a surfactant of the formula:

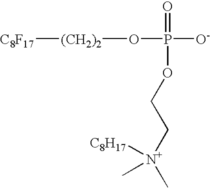

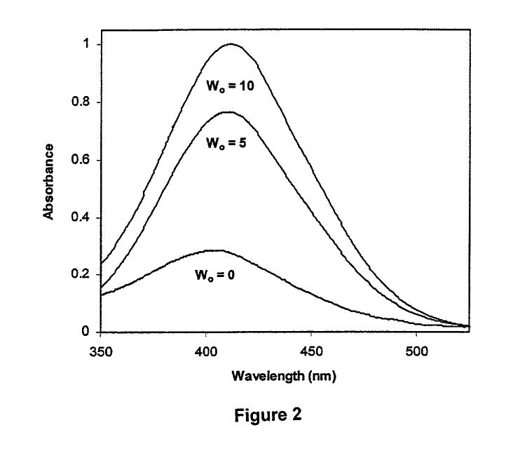

are acquired using a Perkin Elmer Lambda 40 spectrometer. A 2.5 mL stainless steel cell, equipped with two 1 in. diameter×⅝ in. thick sapphire windows enclosing a 1 cm solution path length is employed. Appropriate amount of surfactant (2.5 weight percent) and water (at water/surfactant molar ratios of 0, 5 and 10) are placed into the cell chamber, along with a ¼ in. magnetic stir bar for agitation. A film of methyl orange (for a concentration of 5×10⁻⁵M) is pre-cast and dried on one of the sapphire windows by addition of a stock solution via syringe. Surfactant and water, along with a stir bar, are added to the chamber. The cell is tightly sealed and subsequently pressurized with CO₂, heated to 65 ° C. and 6500 psi add SI units, and stirred until a homogeneous solution is obtained. Absorbance spectra at the different water/surfactant ratios are set forth in FIG. 2.

In the specification and examples there have been disclosed typical preferred embodiments of the invention and, although specific terms are employed, they are used in a generic and descriptive sense only and not for the purposes of limitation, the scope of the invention being set forth in the following claims.

That which is claimed:

1. A surfactant comprising:
a first ionic group comprising at least one hydrocarbon-containing chain;
a second ionic group comprising at least one hydrocarbon-containing chain, wherein said second ionic group has a charge opposite to the charge of said first ionic group; and
a hydrocarbon spacer group covalently bonded to each of said first and second ionic groups;
wherein said surfactant is soluble in carbon dioxide.

2. The surfactant according to claim 1, wherein the first ionic group is of the formula: 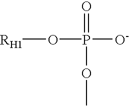
wherein R_{H1} is the hydrocarbon-containing chain.

3. The surfactant according to claim 2, wherein R_{H1} is of the formula:
CₙF₂ₙ₊₁(CH₂)ₘ
wherein n ranges from 4 to 18 and m ranges from 0 to 12.

4. The surfactant according to claim 3, wherein n is 6 and m is 2.

5. The surfactant according to claim 3, wherein n is 8 and m is 2.

6. The surfactant according to claim 2, wherein R_{H1} is of the formula:
HF₂C(CF₂)ₙ(CH₂)ₘ
wherein n ranges from 4 to 18 and m ranges from 0 to 12.

7. The surfactant according to claim 1, wherein the second ionic group is of the formula: 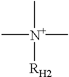
wherein R_{H2} is of the formula C_{q}H_{2q+1} wherein q ranges from 2 to 22, or is an aromatic-containing group.

8. The surfactant according to claim 7, wherein the aromatic-containing group is of the formula:

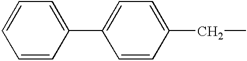

9. The surfactant according to claim 7, wherein q is 8.

10. The surfactant according to claim 7, wherein q is 10.

11. The surfactant according to claim 7, wherein q is 12.

12. The surfactant according to claim 1, wherein the spacer group is of the formula:
(CH₂)ᵣ
wherein r ranges from 1 to 22.

13. The surfactant according to claim 12, wherein r is 2.

14. A composition of matter comprising:
carbon dioxide; and
a surfactant comprising a first ionic group comprising at least one hydrocarbon-containing chain; a second ionic group comprising at least one hydrocarbon-containing chain, wherein said second ionic group has a charge opposite to the charge of said first ionic group; and a hydrocarbon spacer group covalently bonded to each of said first and second ionic groups; and wherein said surfactant is solubilized in the carbon dioxide.

15. The composition of matter according to claim 14, wherein said carbon dioxide is liquid carbon dioxide.

16. The composition of matter according to claim 14, wherein said carbon dioxide is supercritical carbon dioxide.

17. The composition of matter according to claim 14, wherein the first ionic group is of the formula: 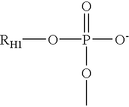
wherein R_{H1} is the hydrocarbon-containing chain.

18. The composition of matter according to claim 17, wherein R_{H1} is of the formula:
CₙF₂ₙ₊₁(CH₂)ₘ
wherein n ranges from 4 to 18 and m ranges from 0 to 12.

19. The composition of matter according to claim 18, wherein n is 6 and m is 2.

20. The composition of matter according to claim 18, wherein n is 8 and m is 2.

21. The composition of matter according to claim 17, wherein R_{H1} is of the formula:
HF₂C(CF₂)ₙ(CH₂)ₘ
wherein n ranges from 4 to 18 and m ranges from 0 to 12.

22. The composition of matter according to claim 14, wherein the second ionic group is of the formula: 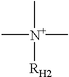
wherein R_{H2} is of the formula C_{q}H_{2q+1} wherein q ranges from 2 to 22, or is an aromatic-containing group.

23. The composition of matter according to claim 22, wherein the aromatic-containing group is of the formula:

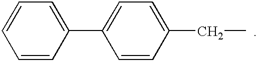

24. The composition of matter according to claim 22, wherein q is 8.

25. The composition of matter according to claim 22, wherein q is 10.

26. The composition of matter according to claim 22, wherein q is 12.

27. The composition of matter according to claim 14, wherein the spacer group is of the formula:
(CH₂)ᵣ
wherein r ranges from 1 to 22.

28. The composition of matter according to claim 27, wherein r is 2.

29. The composition of matter according to claim 14, further comprising a co-solvent.

30. The composition of matter according to claim 14, comprising from about 0.5 weight percent to about 2.5 weight percent of said surfactant.

31. The composition of matter according to claim 14, further comprising water, and wherein said composition of matter comprises a water-to-surfactant molar ratios ranging from about 1:1 to about 1000:1.

32. A process which comprises utilizing the composition of matter as defined by claim 14.

33. The process according to claim 32, wherein said process is selected from at least one of the group consisting of a cleaning process, a coating process, a polymerization process, an enzymatic reaction process, an extraction process, and an inorganic synthesis particle process.
